(19) United States
(12) Patent Application Publication
(10) Pub. No.: US 2026/0178872 A1
(43) Pub. Date: Jun. 25, 2026

(54) QUANTIZATION METHOD OF NEURAL NETWORK MODEL AND ELECTRONIC DEVICE

(71) Applicant: SAMSUNG ELECTRONICS CO., LTD., SUWON-SI (KR)

(72) Inventor: Kefei Liu, Xi'an (CN)

(21) Appl. No.: 19/019,801

(22) Filed: Jan. 14, 2025

(30) Foreign Application Priority Data
Dec. 24, 2024 (CN) 202411918992.6

(51) Int. Cl. G06N 3/04

(52) U.S. Cl. CPC G06N 3/04

(57) ABSTRACT

A quantization method of a neural network model and an electronic device are disclosed. The quantization method comprises: calculating a quantization sensitivity baseline set for each of a plurality of layers of the neural network model, wherein the quantization sensitivity baseline set includes a plurality of quantization sensitivity baselines, and wherein each of the plurality of quantization sensitivity baselines is based on a different corresponding set of bit widths, respectively; calculating a quantization error of a candidate bit width strategy based on the quantization sensitivity baseline set, wherein the candidate bit width strategy allocates a target bit width to each of the plurality of layers; selecting a bit width for each of the plurality of layers based on the quantization error; and processing multimedia data using the neural network model based on the selected bit width.

### CROSS-REFERENCE TO RELATED APPLICATION

This application is based on and claims priority under 35 U.S.C. § 119 to Chinese Patent Application Nos. 202411918992.6, filed on Dec. 24, 2024, in the Chinese Intellectual Property Office, the contents of which are incorporated by reference herein in their entirety.

### TECHNICAL FIELD

The present disclosure relate to a field of neural networks, and more particularly, to a quantization method of a neural network model and an electronic device.

### BACKGROUND

A neural network model, which is a fundamental component of modern artificial intelligence (AI) systems, may have widespread adoption across various applications, including image recognition, natural language processing, autonomous systems, etc. For instance, a neural network model is widely used in multimedia data processing. The models, especially deep neural networks, may be computationally intensive, requiring significant resources in terms of memory and processing power. The increasing complexity and size of neural network models have led to the exploration of optimization techniques to improve performance and efficiency on electronic devices with limited hardware resources.

Model quantization (for example, Mixed Precision Quantization, MPQ) may be considered an effective method to improve a performance and reduce a size of the neural network model. However, in some cases, quantization methods may reduce the precision of the weights and activations within the neural network which may affect the model accuracy and computational efficiency, particularly when deployed on devices with limited computational power and energy resources. Therefore, there is a need in the art for systems and methods that can quantify the neural network model accurately and efficiently with limited computational resources is needed.

### SUMMARY

This summary is provided to introduce a selection of concepts in a simplified form that are further described in the Detailed Description. This summary is not intended to identify key features and/or essential features of the claimed subject matter, nor is it intended to be used as an aid in determining the scope of the claimed subject matter.

The present disclosure describes a quantization method of a neural network model and an electronic device. In some cases, the quantization method of the present disclosure may take into account an influence between related layers of a neural network. For instance, the quantization method may incorporate a result of a quantization of each layer of the network when measuring the sensitivity of the quantized neural network. Accordingly, by incorporating a result of the quantization of each layer, embodiments of the present disclosure are able to enhance the search performance of a mixed precision quantization algorithm without performing extraneous calculations.

According to some example embodiments, there is provided a quantization method of a neural network model used for processing multimedia data comprising calculating a quantization sensitivity baseline set for each of a plurality of layers of the neural network model, wherein the quantization sensitivity baseline set includes a plurality of quantization sensitivity baselines, and wherein each of the plurality of quantization sensitivity baselines is based on a different corresponding set of bit widths, respectively; calculating a quantization error of a candidate bit width strategy based on the quantization sensitivity baseline set, wherein the candidate bit width strategy allocates a target bit width to each of the plurality of layers; selecting a bit width for each of plurality of layers based on the quantization error; and processing multimedia data using the neural network model based on the selected bit width.

According to some example embodiments, there is provided a quantization method of a neural network model used for processing multimedia data comprising dividing the neural network model into a plurality of blocks; calculating a quantization sensitivity baseline set for each of a plurality of layers of a first block of the plurality of blocks, wherein the quantization sensitivity baseline set includes a plurality of quantization sensitivity baselines, and wherein each of the plurality of quantization sensitivity baselines is based on a different corresponding set of bit widths, respectively; calculating a quantization sensitivity for the first block based on the quantization sensitivity baseline sets and a candidate bit width strategy, wherein the candidate bit width strategy allocates a target bit width to each of the plurality of layers of the first block; and selecting a bit width for each the plurality of layers of the first block based on the quantization sensitivity; and processing multimedia data using the neural network model based on the selected bit width.

According to some example embodiments, there is provided an electronic device comprising a sensitivity calculation module configured to calculate a quantization sensitivity baseline set for each of a plurality of layers of a neural network model, wherein the quantization sensitivity baseline set includes a plurality of quantization sensitivity baselines, and wherein each of the plurality of quantization sensitivity baselines is based on a different corresponding set of bit widths, respectively; a quantization error calculation module configured to calculate a quantization error of a candidate bit width strategy based on the quantization sensitivity baseline set, wherein the candidate bit width strategy allocates a target bit width to each of the plurality of layers; and a bit width selection module configured to select a bit width for each of the plurality of layers based on the quantization error.

According to some example embodiments, a computer-readable storage medium stores a computer instructions, wherein the computer instructions, when executed by a processor, implement the above quantization method.

Other aspects and/or advantages of inventive concepts will be partially described in the following description, and part will be clear through the description and/or may be learn through the practice of various example embodiments.

### BRIEF DESCRIPTION OF THE DRAWINGS

The above and other objects, features and advantages of the present disclosure will become clearer through the following detailed description together with the accompanying drawings in which:

FIG. 1 illustrates a neural network model according to an example embodiment.

FIG. 2 illustrates calculation of a quantization sensitivity of a layer based on a layer-independence assumption.

FIG. 3 is a block diagram illustrating a quantization method of a neural network model according to an example embodiment.

FIG. 4 is a diagram illustrating calculation of a quantization sensitivity baseline of a layer according to an example embodiment.

FIG. 5 is a flowchart illustrating calculation of a quantization sensitivity baseline of a layer according to an example embodiment.

FIG. 6 is a block diagram illustrating a method of calculating a quantization sensitivity of a layer according to an example embodiment.

FIG. 7 is a flowchart illustrating calculation of a quantization sensitivity of a layer according to an example embodiment.

FIG. 8 is a diagram illustrating an example of calculating an error of a quantized neural network according to an example embodiment.

FIG. 9 is a block diagram illustrating a quantization method of a neural network model according to an example embodiment.

FIG. 10 is a diagram illustrating an example of calculating an error of a quantized neural network according to an example embodiment.

FIG. 11 is a block diagram illustrating an electronic device according to an example embodiment.

### DETAILED DESCRIPTION

The present disclosure describes systems and methods for implementing a quantization method for neural network models, particularly for improving the neural network efficiency when deployed on an electronic device with limited hardware resources. The rapid growth of neural network applications in everyday consumer electronics, such as smartphones, smart home devices, and autonomous systems, may necessitate the development of quantization methods that ensure efficient neural network operation.

A challenge in implementing a neural network model on an electronic device may be the trade-off between accuracy and efficiency. Existing quantization methods may result in significant losses in model accuracy, particularly when reducing the precision of the weights and activations to lower bit-widths. As a result, existing neural network models may fail to deliver the necessary performance when operating under hardware constraints, limiting usability in real-world applications that require high accuracy and low computational overhead.

Moreover, existing neural network models may generate inaccurate quantization errors. In some cases, existing measurement algorithms may not consider an influence of quantization bit width of other layers on the quantization sensitivity of a current layer which may lead to a difference between a calculated quantization error of neural network and an actual error. Thus, the error difference may further deteriorate a performance of searching for an optimal bit width strategy. In some cases, existing methods may perform additional calculations to improve an accuracy of the quantization error which may result in a further increase of resource consumption (e.g., calculation and time).

By contrast, embodiments of the present disclosure are configured to efficiently and accurately perform a quantization of a neural network model. For example, a deep neural network (DNN) may include a plurality of layers (e.g., convolution layer, fully connected layer, softmax, etc.). According to an embodiment, a distance function may be used to determine the quantization sensitivity for each layer of the network. In some cases, a quantization error of a neural network may be obtained based on a quantization sensitivity of each layer in the neural network.

For instance, the quantization error of the quantized neural network may be computed based on a summation of the quantization sensitivities of each layer of the plurality of layers of the neural network. In some cases, a mixed precision quantization algorithm may be used to incorporate an influence of the quantization error of each parent layer on the current layer. In some examples, the parent layer may refer to each layer of the neural network that may be prior to the current layer.

According to an embodiment of the present disclosure, an optimization algorithm may be used to select an optimal bit width strategy. For example, the bit width strategy may refer to a target bit width for a layer of the neural network model. In some cases, the quantization error of the neural network model may be computed using a quantization baseline set. Additionally, an optimization algorithm may be used to select a bit width for each layer using the quantization error.

In some cases, the quantization sensitivity of a current layer may correspond to a target bit width of each of the parent layers. For instance, the quantization sensitivity may be selected from a set of quantization sensitivity of the current layer. In some examples, a parameter fitting performed with reference to the parent layer may be used to compute the quantization sensitivity of the current layer. In some cases, a linear interpolation may be performed to approximate the quantization sensitivity based on a minimum and a maximum baseline associated with the fitting bit width. A quantization sensitivity of a subsequent layer may be computed using a parameter fitting operation of the parent layers.

Embodiments of the present disclosure may be configured to perform a quantization method of a neural network model for processing multimedia data. In some cases, the method comprises calculating a quantization sensitivity baseline set for each of a plurality of layers of a neural network model. For instance, the quantization sensitivity baseline set may include a plurality of quantization sensitivity baselines and each of the plurality of quantization sensitivity baselines may be based on a different corresponding set of bit widths, respectively. Subsequently, a quantization error of a candidate bit width strategy may be computed using the calculated quantization sensitivity baseline set. In some cases, the candidate bit width strategy may allocate a target bit width to each of the plurality of layers. In some cases, the method further comprises selecting a bit width for each of the plurality of layers based on the quantization error and processing the multimedia data using the neural network model based on the selected bit width.

An embodiment of the present disclosure may be configured to perform a quantization of a neural network model. In some cases, the method comprises dividing the neural network model into a plurality of blocks. A quantization sensitivity baseline set may be computed for each of a plurality of layers of a first block of the plurality of blocks. Subsequently, a quantization sensitivity may be computed for the first block based on the quantization sensitivity baseline set and a candidate bit width strategy. As described herein, the quantization sensitivity may be used to select a bit width for each of the plurality of layers of the first block and the multimedia data may be processed using the neural network model based on the selected bit width.

Accordingly, by incorporating a quantization result of each layer of the neural network model, embodiments of the present disclosure are able to reduce the model size and computational complexity without compromising the accuracy of the neural network. Additionally, since the quantization influence of the parent layers may be transferred to the current layer, a neural network quantization error reflecting the quantization influence of each layer of the neural network may be obtained resulting in high accuracy and low computational overhead.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed herein are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of normal skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals allocated to the elements in the drawings, it should be noted that the same elements will be designated by the same reference numerals, and redundant descriptions thereof will be omitted.

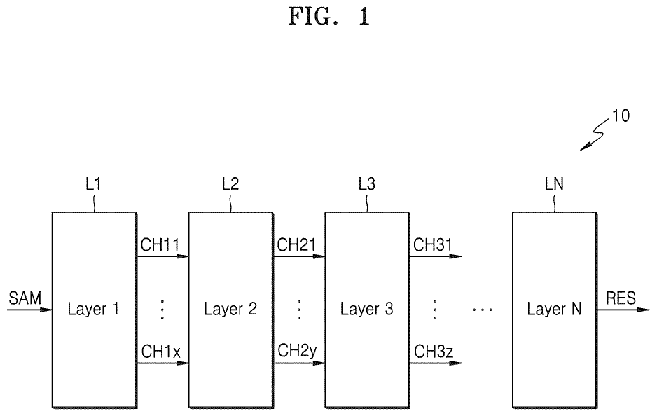

FIG. 1 illustrates a neural network model according to an example embodiment.

For example, FIG. 1 schematically illustrates the structure of a deep neural network 10 according to an example embodiment.

The neural network model may refer to a computing system focused on a biological neural network constituting an animal brain. The neural network model may be trained to perform tasks by considering multiple samples (or examples), unlike classical algorithms that perform tasks according to predefined conditions, such as rule-based programming. The neural network model may have a structure in which artificial neurons (or neurons) are connected, and a connection between neurons may be referred to as a synapse. A neuron may process received signals and transmit the processed signals to another neuron through the synapse. The output of the neuron may be referred to as activation. The neuron and/or synapse may have a variable weight, and the influence of the signal processed by the neuron may increase or decrease depending on the weight. Particularly, the weight associated with an individual neuron may be referred to as a bias.

In some cases, an artificial neural network (ANN) can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

In some examples, parameters of the neural network can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the neural network parameters are learned from the training data, the neural network can be used to make predictions on new, unseen data (i.e., during inference).

A deep neural network (DNN) or a deep learning architecture may have a layer structure, and output of a specific layer may be an input of a subsequent layer. In such a multi-layered structure, each of the layers may be trained according to multiple samples. The neural network model, such as DNN may be implemented by a number of processing nodes corresponding to neurons respectively, which may require higher computational complexity so as to obtain good results, such as higher accuracy results, and, accordingly, many computing resources may be required.

Referring again to FIG. 1, a DNN 10 may include a plurality of layers L1, L2, L3, . . . , LN (e.g., N may be an integer greater than 3). In some cases, the output of a layer may be input to a subsequent layer through at least one channel. For example, the first layer L1 may provide an output to the second layer L2 through a plurality of channels CH11 . . . . CH1x by processing a sample SAM. Additionally, for example, the second layer L2 may provide an output to the third layer L3 through a plurality of channels CH21 . . . . CH2y. Similarly, the Nth layer LN may output a result RES. In some cases, the result RES may include at least one value related to the sample SAM. The number of channels through which the outputs of the plurality of layers L1, L2, L3, . . . , LN are transferred may be the same or different. For example, the number of channels CH21 . . . . CH2y of the second layer L2 and the number of channels CH31 . . . . CH3z of the third layer L3 may be the same or different. For example, as used herein, x, y, and z may be integers greater than 1.

The sample SAM may refer to input data processed by DNN 10. For example, the sample SAM may include multimedia data (such as but not limited to image data, voice data, text data, etc.).

According to an example embodiment, the DNN 10 may include a large number of layers or channels. Accordingly, the computational complexity of the DNN 10 may increase. DNN 10 with high computational complexity may require a high number of resources. Therefore, DNN 10 may be quantized to reduce the computational complexity of the DNN. As a result, quantized DNN 10 may have low computational complexity and may have reduced accuracy due to an error occurring in the quantization process.

In some cases, low-precision quantization methods may compress and accelerate a neural network by quantizing floating-point values of weights and/or activation values into integer values with specified bit widths. A low-precision quantization technique may include mixed-precision quantization comprising quantizing each layer of the plurality of layers in DNN 10 according to a specific bit width. In some cases, each layer may be quantized by setting different integer bit widths for different layers of the neural network, thus utilizing (e.g., completely utilizing) the quantization performance of the network. In some cases, efficiently searching an optimal solution needed by the neural network in the solution space may be a key of neural network quantization since mixed precision quantization may lead to an exponential solution space.

In some cases, the measurement-based mixed precision quantization method may allocate the corresponding bit width to each layer of the plurality of layers by reasonably measuring the quantization sensitivity of each layer in the neural network. The quantization sensitivity of each layer in the neural network may refer to the sensitivity of the layer to quantization error. In some cases, the model performance may be more disturbed than other layers when a layer with high sensitivity is quantized to a certain bit width. For example, a layer with high sensitivity may need to be allocated with a larger bit width than the remaining layers. By measuring or calculating the quantization sensitivity, embodiments of the present disclosure may be able to perform an efficient search in the original solution space based on optimization algorithms (e.g., multi-objective optimization algorithm, greedy search algorithm, etc.) to find a best bit width strategy.

In some cases, when measuring the quantization error of the neural network, existing measurement-based mixed precision quantization methods may be based on a simplified assumption, i.e., a layer-independence assumption in which the quantization sensitivities of different layers are independent of the quantization bit width selection of other layers. In some cases, the layer-independence assumption may be used since performing an actual measurement of the quantization error of a complete quantized neural network may be time consuming. Additionally, multiple calculations on the quantized neural network may be needed for the actual measurement. In some cases, the quantization error of the quantized neural network may be obtained by adding the quantization sensitivities of each layer based on the layer-independence assumption resulting in a reduction of resources used in the search (e.g., time, cost of search, etc.).

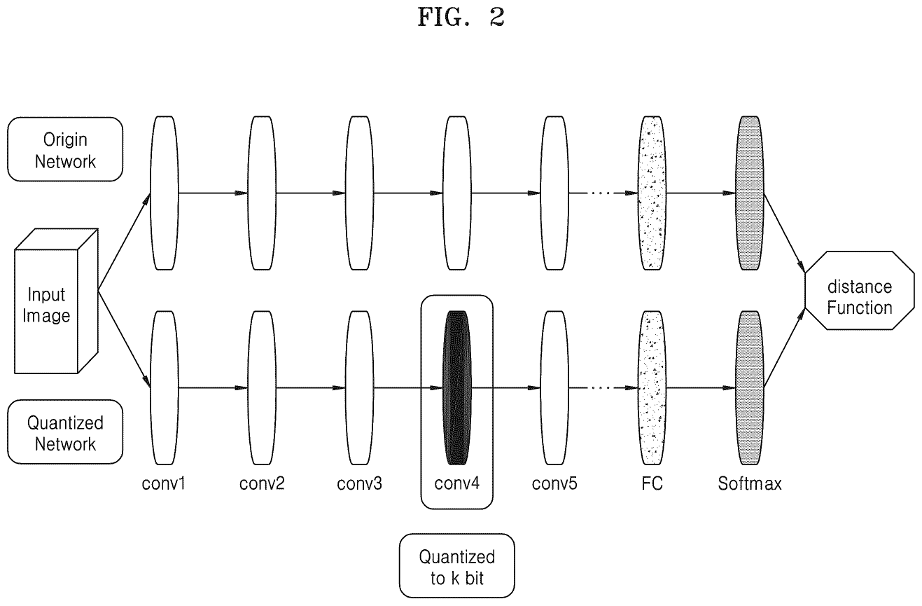

FIG. 2 illustrates an example of a method of calculating a quantization sensitivity of a layer based on the layer-independence assumption.

Referring to FIG. 2, the neural network model (or the neural network) may include a plurality of layers, for example, conv1 to conv5, a fully connected layer FC, and a softmax layer Softmax. For example, the quantization sensitivity of a specific layer (e.g., conv4) of the neural network may be calculated by calculating a distance between an output of the neural network before quantization (i.e., the original neural network) and an output of a quantized neural network in which a specific layer (e.g., conv4) may be quantized to a specific bit width (e.g., k bits) followed by adding the quantization sensitivities of each layer to obtain a quantization error of the quantized neural network.

In some cases, a difference between the quantization error of the neural network obtained based on the layer-independence assumption and the actual quantization error of neural network may be amplified as the complexity of the model structure increases. As a result, the search for the best bit width strategy may be affected. Therefore, in some cases, a mixed precision quantization algorithm may need an addition of extra calculation steps in the searching to correct the said difference. Additionally, as the extra calculation steps may be used to evaluate a real error of the quantization neural network corresponding to the bit width strategy to be selected. In some cases, such extra calculation steps may lead to more calculation and time-consumption.

Embodiments of the present disclosure include a mixed precision quantization method of neural network model. In some cases, an influence of quantization errors of each parent layer of a current layer (i.e., the layers that provide effective input for the current layer) may be implemented on the current layer when measuring the sensitivity of the layer. Additionally, the influence may be simulated and passed back through a fitting (e.g., a linear interpolation fitting). Accordingly, by incorporating the influence of the quantization error of the parent layers, embodiments of the present disclosure are able to accurately calculate the error of the quantized neural network without introducing unnecessary extra calculation which significantly improves the search performance of the mixed precision quantization algorithm.

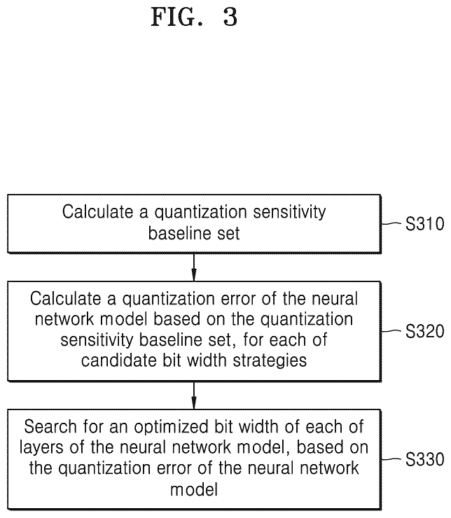

FIG. 3 is a block diagram illustrating a quantization method of a neural network model according to an example embodiment.

Referring to FIG. 3, in step S310, a quantization sensitivity baseline set may be calculated for each layer of the neural network model. For example, a quantization sensitivity baseline set may refer to a reference point or starting condition used to evaluate the sensitivity of different parts of a neural network model (such as layers, weights, and activations) to quantization. In some examples, the sensitivity baseline may guide the quantization process based on identifying critical components of the model that need special consideration when reducing bit-widths.

For example, a set of quantization sensitivity baselines may be calculated for each layer of the neural network model. In some cases, the quantization sensitivity baselines may be based on different corresponding set of bit widths. In some examples, each quantization sensitivity baseline may refer to the quantization sensitivity of the current layer when the current layer is quantized to k bits and each parent layer of the current layer is quantized to p bits. Each parent layer of the plurality of parent layers of the current layer may represent the layers that provide input for the current layer. For example, each parent layer of the current layer may represent layers located before the current layer.

In step S320, a quantization error of the neural network model may be calculated based on the quantization sensitivity baseline set for each candidate bit width strategy of the plurality of candidate bit width strategies. In some cases, each of plurality of the candidate bit width strategies may allocate a target bit width to each layer of the neural network model.

In some cases, a bit-width strategy may refer to the number of bits allocated for representing the weights, activations, and other elements in the neural network after quantization. For example, the bit-width strategy may include varying the precision levels across different layers of the network based on the sensitivity to quantization.

In step S330, an optimization algorithm may be used to select a bit width for each layer of the plurality of layers of the neural network model based on the quantization error of the neural network model. For example, the optimal bit width of each layer of the neural network model may be searched based on a multi-objective optimization algorithm, a greedy algorithm, and the like.

A multi-objective optimization algorithm is a type of algorithm designed to optimize multiple conflicting objectives simultaneously. For instance, in the context of neural network quantization, the multi-objective optimization algorithm may be used to balance minimizing model size (for efficiency) and maintaining model accuracy (for performance). In some cases, the multi-objective optimization algorithm may find a set of solutions that may provide optimum trade-offs between the competing objectives.

A greedy algorithm may refer to an iterative approach that makes a series of decisions by choosing the most desirable option available at each step, without considering the broader consequences or long-term impact. In the context of neural network quantization, a greedy algorithm may decide an optimal bit-width for each layer at a time. For instance, the greedy algorithm may start with the most critical layers (based on sensitivity), quantize the layers with high precision, and proceed to less critical layers with progressively low precision.

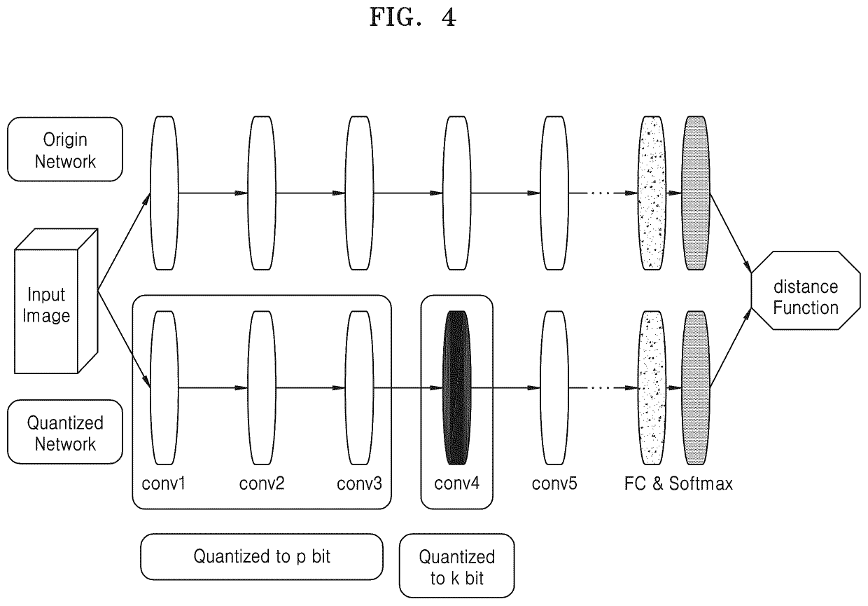

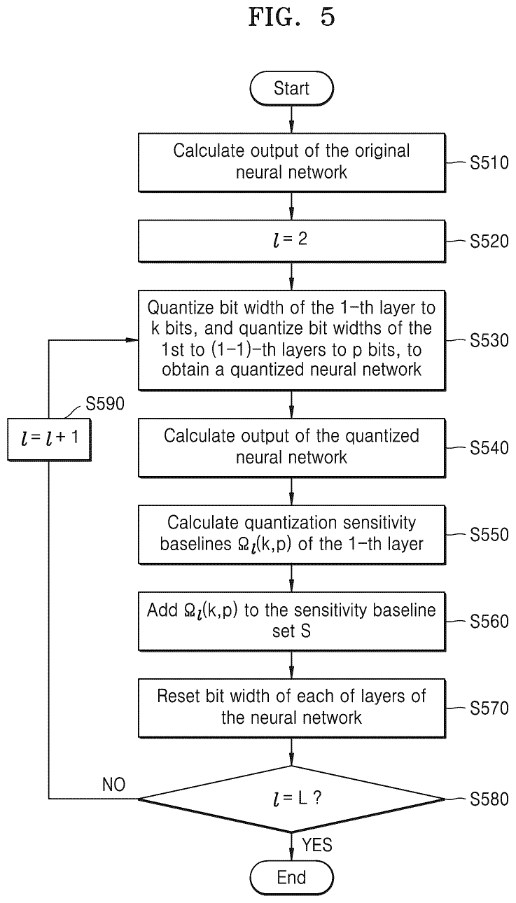

FIG. 4 illustrates calculation of a quantization sensitivity baseline of a layer according to some example embodiments. FIG. 5 is a flowchart illustrating calculation of a quantization sensitivity baseline of a layer according to some example embodiments.

Referring to FIG. 4, when calculating the sensitivity baseline set for the fourth layer conv4 of the neural network model, each parent layer of the fourth layer conv4, i.e., conv1 to conv3, may be quantized to p bits and conv4 may be quantized to k bits. The distance between the output of the original neural network and the output of the quantized neural network may be calculated by a distance function. In some cases, the distance may be used as the baseline set Ω₄(k, p) of the quantization sensitivity of the fourth layer conv4. The quantization sensitivity baseline set Ω₄(k, p) may have multiple quantization sensitivity baselines based on different combinations of values of k and p.

In some cases, the neural network model has L layers. The quantization sensitivity baseline set Ωₗ(k, p) may be calculated for each layer of the neural network model (i.e., except the first layer), where 1≤l≤L, where k represents a quantization bit width of the l-th layer, and p represents a quantization bit width of layer 1 to layer (l−1).

Referring to FIG. 5, in step S510, an output M(X) of the original neural network M may be calculated. For example, a calibration data set X may be input into the original neural network M, and the output M(X) may be obtained by traversing each layer of the original neural network M. The original neural network M may refer to the neural network before quantization (i.e., the neural network which may not be quantized). For example, the bit width of each layer of the original neural network M may be a 32-bit floating point number.

In step S520, l may be set to 2. In some cases, the sensitivity baseline set may be calculated from the second layer of the neural network model.

In step S530, the l-th layer may be quantized to k bits and each parent layer of the plurality of parent layers of the l-th layer (for example, layer 1 to layer (l−1)) may be quantized to p bits. As a result, a quantized neural network M′ may be obtained.

In step S540, the output M′(X) of the quantized neural network M′ may be obtained based on the calibration data set X.

In step S550, the quantization sensitivity baseline 21 (k, p) of the l-th layer may be calculated. For example, the quantization sensitivity baseline may be computed based on a distance between the output M′(X) of the quantized neural network M′ and the output M(X) of the original neural network M, Ωₗ(k, p). In some cases, the distance may be calculated using a distance function.

Steps S530 to S550 may be repeatedly performed based on combinations of values of k and p to obtain a plurality of quantization sensitivity baselines Ωl(k, p).

In step S560, the plurality of quantization sensitivity baselines Ωl(k, p) of the l-th layer obtained may be added to the sensitivity baseline set S.

In step S570, the bit width of each layer of the plurality of layers of the neural network model may be reset. For example, the bit width of each layer of the neural network model may be reset to the bit width of the original neural network.

In step S580, when the l-th layer is not a last layer of the neural network model, the value of l may be increased by 1 in step S590 (i.e., l=l+1), and then steps S530 to S570 may be executed repeatedly.

In some cases, the quantization error of the neural network model may be calculated for each candidate bit width strategy of the plurality of candidate bit width strategies after obtaining the quantization sensitivity baseline set of each layer.

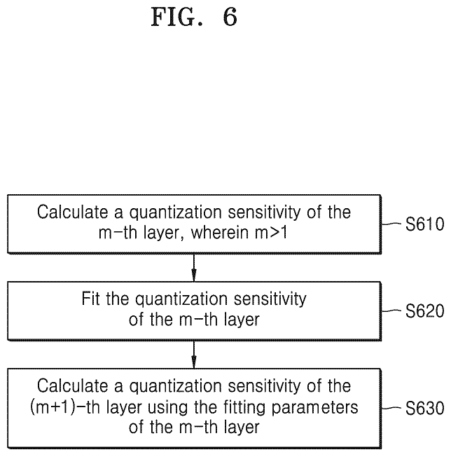

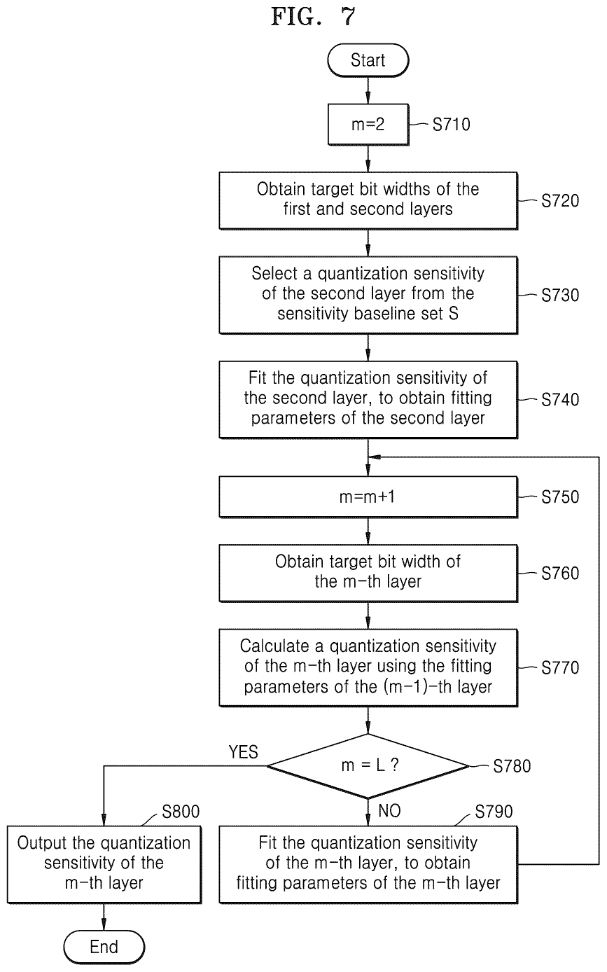

FIG. 6 is a block diagram illustrating a method of calculating a quantization sensitivity of a layer according to an example embodiment. The steps in FIG. 6 may correspond to step S320 described with reference to FIG. 3. FIG. 7 is a flowchart illustrating calculation of a quantization sensitivity of a layer according to an example embodiment.

Referring to FIG. 6, in step S610, the quantization sensitivity of the m-th layer may be calculated based on the target bit width of the m-th layer, where m is an integer greater than 1.

For example, when the m-th layer refers to the second layer of the neural network model, the quantization sensitivity baseline may be directly selected as the quantization sensitivity of the m-th layer from among the quantization sensitivity baseline set of the second layer. In some cases, the quantization sensitivity baseline may correspond to the target bit widths of the first and second layers.

In case of the third layer to the last layer of the neural network model, the fitting parameters of the previous layer may be used to calculate the quantization sensitivity of the current layer with the target bit width.

In step S620, the quantization sensitivity of the m-th layer may be fitted to obtain the fitting parameters of the m-th layer, wherein the fitting process may be based on the quantization sensitivity baseline set of the m-th layer. The fitting parameters of the m-th layer may include a set of weights and a plurality of fitting bit widths, wherein a sum of the weights may be 1.

According to an example, the quantization sensitivity of the m-th layer may be approximated (e.g., using a linear interpolation algorithm) based on a weighted sum of two certain quantization sensitivity baselines in the quantization sensitivity baseline set of the m-th layer. For example, the quantization sensitivity of the m-th layer may be fitted using the quantization sensitivity baselines Ωₘ(bₘᵢₙ, bₘᵢₙ) and Ωₘ(bₘₐₓ, bₘₐₓ). Here, Ωₘ(bₘᵢₙ, bₘᵢₙ) refers to a quantization sensitivity baseline when the bit widths of the first to the m-th layers may be quantized to a first fitting bit width bₘᵢₙ. Additionally, Ωₘ(bₘₐₓ, bₘₐₓ) is a quantization sensitivity baseline when the bit widths of the first to the m-th layers may be quantized to a second fitting bit width bₘₐₓ.

In some cases, a fitting bit width may refer to the process of determining the most appropriate bit-width for representing the weights and activations of a neural network model (e.g., taking into account both the computational requirements and the desired accuracy). In some cases, the fitting bit width may be used to fit the bit-width to the sensitivity of different parts of the model such that the precision used is sufficient to maintain performance while minimizing resource usage. Equation (1) illustrates an example of fitting the quantization sensitivity of the m-th layer, where bₘᵢₙ and bₘₐₓ may represent the fitting bit widths of the m-th layer, and λ^{(m)} may represent the weight parameter of the m-th layer.

$${Ω}_{m} ( k , p ) \approx {λ}^{( m )} \times {Ω}_{m} ( {b}_{min} , {b}_{min} ) + ( 1 - {λ}^{( m )} ) \times {Ω}_{m} ( {b}_{max} , {b}_{max} ) \qquad ( 1 )$$

According to an example, the first fitting bit width bₘᵢₙ and the second fitting bit width bₘₐₓ may be selected based on a comparison between the quantization sensitivity of the m-th layer calculated in step S610 and a plurality of quantization sensitivity baselines of the m-th layer.

For example, the quantization bit width selection of the m-th layer may be assumed to include 2 bits, 4 bits, 6 bits and the like. In case of the quantization sensitivity baseline set of the m-th layer, a plurality of quantization sensitivity baselines, i.e., Ωₘ(2, 2), Ωₘ(4,4), Ωₘ(6, 6), etc. may exist in which bit widths of the first to the m-th layers may be quantized to the same bit width. In some examples, two quantization sensitivity baselines that may be closest to the quantization sensitivity of the m-th layer may be selected from among the quantization sensitivity baselines for fitting. For example, when Ωₘ(k, p) is located at an interval of (Ωₘ(4,4), Ωₘ(6, 6)), the first fitting bit width bₘᵢₙ may be selected as 4 bits and the second fitting bit width bₘₐₓ may be selected as 6 bits. The weight parameters of the m-th layer may subsequently be obtained based on the linear interpolation algorithm.

Although the above example illustrates that two quantization sensitivity baselines may be used to approximate the quantization sensitivity of the m-th layer, embodiments of the present disclosure may not be limited thereto. In some cases, three or more quantization sensitivity baselines may be used for fitting as needed.

In step S630, the quantization sensitivity of the (m+1)-th layer may be calculated based on the target bit width of the (m+1)-th layer using the fitting parameters of the m-th layer.

In case of the third layer to the last layer of the neural network model, the fitting parameters of the previous layer m may be used to calculate the quantization sensitivity of the current layer m+1 with the target bit width of k bits.

As shown with reference to Equation (2), two certain sensitivity baselines in the quantization sensitivity baseline set of the (m+1)-th layer may be used to calculate the quantization sensitivity when the target bit width of the (m+1)-th layer is k. In some cases, one of the two certain sensitivity baselines may correspond to the bit width of the (m+1)-th layer being quantized to k bits and the bit widths of the first layer to the m-th layer being quantized to the first fitting bit width bₘᵢₙ. Additionally, in some cases, the other one of the two certain quantization sensitivity baseline may correspond to the bit width of the (m+1)-th layer being quantized to k bits and the bit widths of the first layer to m-th layer being quantized to the second fitting bit width bₘₐₓ.

$${Ω}_{m + 1} ( k ) = {λ}^{( m )} \times {Ω}_{m + 1} ( k , {b}_{min} ) + ( 1 - {λ}^{( m )} ) \times {Ω}_{m} ( k , {b}_{max} ) \qquad ( 2 )$$

Next, referring to equation (3), the quantization sensitivity Ωₘ₊₁(k) of the (m+1)-th layer may be fitted using the linear interpolation to obtain the fitting parameters of the (m+1)-th layer. As used herein, pₘᵢₙ and pₘₐₓ may represent the fitting bit widths of the (m+1)-th layer, and λ^{(m+1)} may represent the weight parameter of the (m+1)-th layer.

$${Ω}_{m + 1} ( k ) \approx {λ}^{( m + 1 )} \times {Ω}_{m + 1} ( k , {p}_{min} ) + ( 1 - {λ}^{( m + 1 )} ) \times {Ω}_{m + 1} ( k , {p}_{max} ) \qquad ( 3 )$$

In case of the third layer to the last layer of the neural network, steps S610 to S630 may be performed cyclically. In some cases, the quantization sensitivity Ωₘ₊₁(k) of the (m+1)-th layer may be determined as the quantization error of the neural network model under the current bit width strategy when the (m+1)-th layer is the last layer of the neural network model.

Referring to FIG. 7, in step S720, the value of m may be 2. In some cases, the quantization sensitivity may be calculated from the second layer of the neural network model.

In step S730, the target bit widths of the first layer and the second layer may be obtained from the candidate bit width strategy.

In step S740, the quantization sensitivity of the second layer may be selected from the sensitivity baseline set S. For example, the sensitivity baseline corresponding to the target bit widths of the first layer and second layer may be selected from the sensitivity baseline set S as the quantization sensitivity of the second layer. For instance, in step S740, the quantization sensitivity of the second layer may be fitted to obtain fitting parameters of the second layer.

In step S750, the value of m may be increased by 1 (i.e., m=m+1).

In step S760, the target bit width of the m-th layer may be obtained from the candidate bit width strategy.

In step S770, the quantization sensitivity of the m-th layer may be calculated using the fitting parameters of the (m−1)-th layer.

When it is determined in step S780 that the m-th layer is not the last layer of the neural network model, the quantization sensitivity of the m-th layer may be fitted in step S790 to obtain fitting parameters of the m-th layer. Subsequently, steps S750 to S780 may be performed repeatedly.

In step S780, a determination may be made if the m-th layer is the last layer of the neural network model, and in step S800, the quantization sensitivity of the m-th layer may be output as the quantization sensitivity of the neural network model (Step S780: Yes).

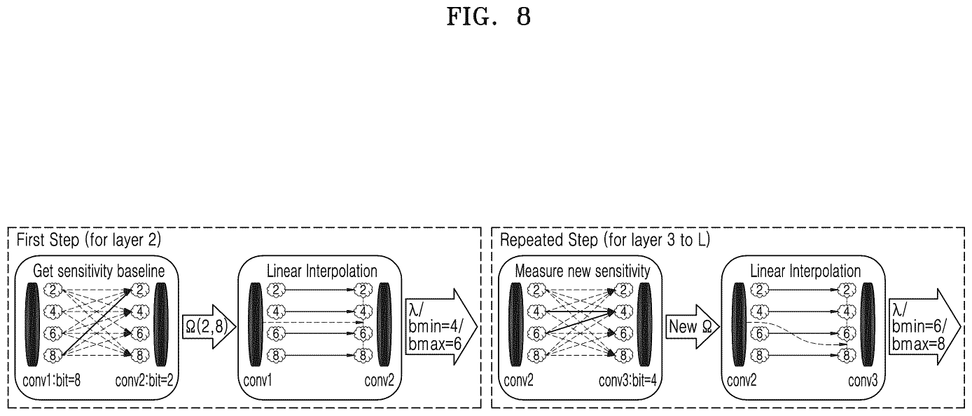

FIG. 8 is a diagram illustrating an error calculation of a quantized neural network according to some example embodiments.

Referring to FIG. 8, the target bit width of the first layer may be assumed as 8 bits under the current candidate bit width strategy and the target bit width of the second layer may be assumed as 2 bits under the current candidate bit width strategy. As a first step, Ω₂(2, 8) may be selected as the quantization sensitivity of the second layer from the quantization sensitivity set Ω₂(k, p) of the second layer.

Next, Ω₂(2,8) may be fitted using two certain baselines in the quantization sensitivity baseline set of the second layer. For example, Ω₂(2, 8) may be fitted based on two quantization sensitivity baselines where the bit widths of the first and second layers may be quantized to a same value using the linear interpolation algorithm. For example, the fitting bit width may be selected as: bₘᵢₙ=4, bₘₐₓ=6, and Ω₂(2, 8) may be fitted using the linear interpolation because the value of Ω₂(2, 8) may be located in the interval of Ω₂(4,4), Ω₂(6, 6)).

$${Ω}_{2} ( 2 , 8 ) \approx {λ}^{( 2 )} \times {Ω}_{2} ( 4 , 4 ) + ( 1 - {λ}^{( 2 )} ) \times {Ω}_{2} ( 6 , 6 ) \qquad ( 4 )$$

After obtaining the fitting parameters of the second layer (for example, λ⁽²⁾, bₘᵢₙ=4 and bₘₐₓ=6), two certain baselines in the quantization sensitivity baseline set of the third layer may be used to calculate the quantization sensitivity Ω₃(4) when the target bit width of the third layer is 4 bits:

$${Ω}_{3} ( 4 ) = {λ}^{( 2 )} \times {Ω}_{3} ( 4 , 4 ) + ( 1 - {λ}^{( 2 )} ) \times {Ω}_{3} ( 4 , 6 ) \qquad ( 5 )$$

In some cases, two quantization sensitivity baselines Ω₃(6, 6) and Ω₃(8, 8) closest to Ω₃(4) may be selected based on the calculated Ω₃(4), and Ω₃(4) may be fitted by the linear interpolation to obtain the fitting parameters of the third layer (for example, λ⁽³⁾, bₘᵢₙ=6 and bₘₐₓ=8).

$${Ω}_{3} ( 4 ) \approx {λ}^{( 3 )} \times {Ω}_{3} ( 6 , 6 ) + ( 1 - {λ}^{( 3 )} ) \times {Ω}_{3} ( 8 , 8 ) \qquad ( 6 )$$

The processing for the third layer may be cyclically performed for the fourth to the last layers of the neural network. When the (m+1)-th layer is the last layer of the neural network, the calculated quantization sensitivity of the (m+1)-th layer may be determined as the quantization error of the neural network under the current bit width strategy.

Accordingly, the quantization influence of the parent layers may be transferred to the current layer such that a neural network quantization error reflecting the quantization influence of each layer of the plurality of layers may be obtained. In some cases, the neural network quantization error calculated based on the layer-independence assumption may include substantial calculation and may have low accuracy. By contrast, the quantization error calculation method of the present disclosure may more accurately approximate the actual quantization neural network error without introducing extraneous calculation.

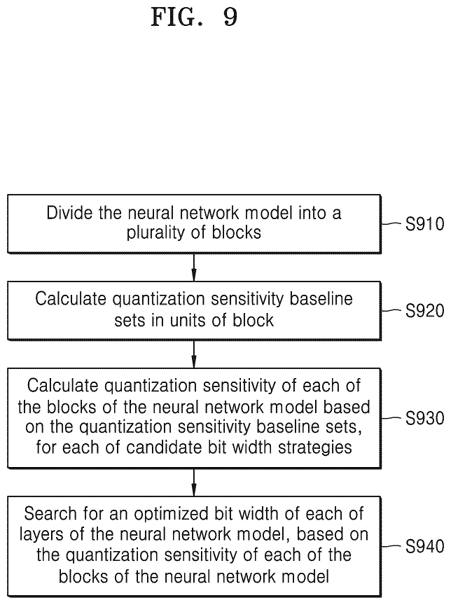

FIG. 9 is a block diagram illustrating a quantization method of a neural network model according to some example embodiments.

In case of a concatenated layer in the neural network model, the current layer may have multiple parallel parent layers. In some cases, the neural network model may be divided into a plurality of blocks and the quantization sensitivity baseline sets of the neural network model may be calculated in units of blocks. In some cases, the quantization sensitivity of each block of the plurality of blocks of the neural network model may be calculated based on the quantization sensitivity baseline sets, and the optimized bit width of each layer of the plurality of layers of the neural network model may be searched based on the quantization sensitivity of each of the blocks.

Referring to FIG. 9, in step S910, the topological structure of the neural network may be analyzed to divide the neural network model into the plurality of blocks. For example, in case of a neural network model comprising parallel branches, the parallel branches and the concatenated layer may be combined to form one block.

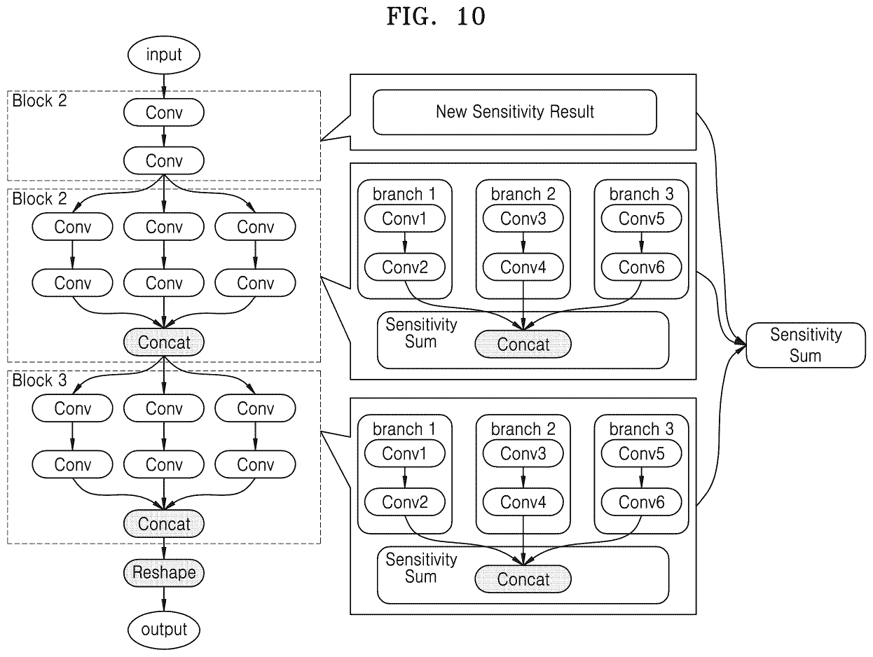

FIG. 10 is a diagram illustrating another example of calculating an error of a quantized neural network according to some example embodiments.

FIG. 10 illustrates a topological structure of the neural network model. Additionally, FIG. 10 illustrates the result of dividing the neural network model into blocks. Although FIG. 10 illustrates the specific structure of the neural network model, embodiments may not be limited thereto, and the description and structure of the neural network model may be modified as needed.

Referring again to FIG. 10, the middle layers of the neural network model may be divided into three blocks, i.e., Block 1, Block 2 and Block 3. For example, Block 1 may include two convolution layers Conv. Additionally, Block 2 and Block 3 may each include three parallel branches, i.e., branch 1, branch 2, branch 3, and a concatenated layer Concat. Additionally, each branch may include two convolution layers (for example, branch 1 may include Conv1 and Conv2, branch 2 may include Conv3 and Conv4, and branch 3 may include Conv5 and Conv6).

Referring again to FIG. 9, in step S920, the quantization sensitivity baseline sets may be calculated in units of blocks.

The quantization sensitivity baseline set may be calculated for each layer of the plurality of layers in the current block of the neural network model. For example, a quantization sensitivity baseline set may be calculated for each layer of the plurality of layers in the current block. In some examples, each quantization sensitivity baseline may refer to the quantization sensitivity of the current layer when the current layer may be quantized to k bits and each parent layer of the plurality of parent layers of the current layer may be quantized to p bits. The parent layer of the current layer may represent the layers in the current block that may provide input for the current layer.

In step S930, the quantization sensitivity of each block of the plurality of blocks of the neural network model may be calculated for each of the candidate bit width strategies based on the quantization sensitivity baseline sets.

According to an example, the influence of the bit width selection of other blocks on the quantization error of the current block may not be considered when calculating the quantization sensitivity of a block (i.e., even if other blocks provide input for the layer of the current block).

Referring again to FIG. 10, the quantization sensitivity of the block may be first calculated for Block 1. For example, the quantization sensitivity of each layer of the plurality of layers in Block 1 may be calculated based on the method described with reference to FIGS. 3 to 8. In some cases, the quantization sensitivity of the last layer in Block 1 may be determined as the quantization sensitivity of Block 1.

Subsequently, quantization sensitivity of the block may be calculated for Block 2. In some cases, the layers in Block 1 may provide an input for the layers in Block 2 (e.g., at the time of computation for Block 2). In some cases, the quantization bit width of each layer of the plurality of layers in Block 1 may not be considered when calculating the sensitivity in units of block, i.e., the quantization sensitivity of Block 2 may be calculated without quantizing the bit width of each layer of the plurality of layers in Block 1.

Additionally, the quantization sensitivity of the layer may be calculated separately for each branch in Block 2 and the quantization sensitivity of Block 2 may be calculated by adding the quantization sensitivities of each of the corresponding branches (i.e., branch 1, branch 2, and branch 3). Referring to FIG. 10, the quantization sensitivities of layer Conv2, layer Conv4, and layer Conv6 in Block 2 may be added to obtain the quantization sensitivity of Block 2.

Additionally, the quantization sensitivity of Block 3 may be calculated in a similar manner (i.e., similar to Block 2).

In step S940, an optimized bit width of each layer of the plurality of layers of the neural network model may be searched based on the quantization sensitivities of the plurality of blocks. For example, the optimal bit width of each layer of the plurality of layers of the neural network model may be searched based on multi-objective optimization algorithm, greedy algorithm, etc.

According to an example, a bit width strategy search may be performed based on traversing each of the blocks.

For example, in case of Block 1, Pareto boundary 1 may be obtained using the multi-objective optimization algorithm (MOOA) based on the quantization sensitivity calculation result of Block 1. Subsequently, the quantization sensitivity of Block 2 may be calculated and the Pareto boundary 2 may be obtained using the MOOA.

As used herein, the Pareto boundary may represent a set of optimal trade-off solutions (e.g., where no single objective may be improved without degrading another objective). In some cases, the objectives may include, but not limited to, minimizing model size or computational complexity (e.g., reducing bit-width) and maximizing accuracy or performance. For example, when performing an optimization, a reduction of bit width to 4 bits for the weights may reduce the memory and power consumption while causing a slight drop in accuracy. Additionally or alternatively, use of 8 bits may maintain high accuracy but at an undesired computational cost. Accordingly, such configurations that balance between the factors (i.e., power consumption and accuracy) may be part of the Pareto boundary, i.e., improving efficiency may lead to undesirable performance degradation and vice versa.

In some cases, Pareto boundary 1 of Block 1 and Pareto boundary 2 of current Block 2 may be combined and the MOOA based on the layer-independence assumption may be run again to obtain the optimal bit width strategy set of the first Block 1 to the current Block 2. Next, for each of the subsequent blocks, the processing for Block 2 may be repeated until the optimal bit width strategy set of the complete model is obtained. The optimal bit width strategy under specific conditions may be selected from the set of optimal bit width strategies according to the target scale.

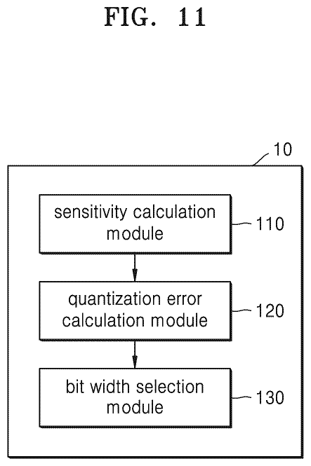

FIG. 11 is a block diagram illustrating an electronic device according to an example embodiment.

The electronic device according to an example embodiment of the present disclosure may include, for example, a desktop computer, a laptop computer, a tablet computer, a server system, and the like. However, the present disclosure is not limited thereto, and the electronic device according to the present disclosure may be any electronic device having the function of processing multimedia data.

As shown in FIG. 11, an electronic device 10 may include a sensitivity calculation module 110, a quantization error calculation module 120, and a bit width selection module 130.

According to an exemplary embodiment, the sensitivity calculation module 110 may calculate a quantization sensitivity baseline set for each layer of the neural network model. The calculation of the quantization sensitivity baseline set has been described in detail with reference to FIG. 5 and repeated description may be omitted herein to avoid redundancy.

In some cases, the quantization error calculation module 120 may calculate a quantization error of the neural network model based on the quantization sensitivity baseline set for each of the candidate bit width strategies. The quantization error calculation module 120 may calculate the quantization sensitivity of the m-th layer based on the target bit width of the m-th layer. Next, the calculated quantization sensitivity may be fitted based on the quantization sensitivity baseline set of the m-th layer to obtain fitting parameters of the m-th layer. Additionally, the quantization error calculation module 120 may calculate the quantization sensitivity of the (m+1)-th layer using the fitting parameters of the m-th layer based on the target bit width of the (m+1)-th layer. When the (m+1)-th layer is the last layer of the neural network model, the quantization error calculation module 120 may determine the quantization sensitivity of the (m+1)-th layer as the quantization error of the neural network model under the candidate bit width strategy.

In some cases, the bit width selection module 130 may search for an optimized bit width of each layer of the plurality of layers of the neural network model based on the quantization error of the neural network model.

According to an exemplary embodiment, the sensitivity calculation module 110 may further divide the neural network model into a plurality of blocks and may calculate quantization sensitivity baseline sets in units of blocks.

The quantization error calculation module 120 may calculate the quantization sensitivity of each block of the neural network model based on the quantization sensitivity baseline sets.

In some cases, the bit width selection module 130 may search for an optimized bit width of each layer of the neural network model based on the quantization sensitivity of each block of the neural network model.

The apparatus, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result.

According to an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both.

For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

According to an embodiment, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions and/or software include machine code that is directly executed by the processor or computer, such as machine code produced by a compiler. In another example, the instructions or software include higher-level code that is executed by the processor or computer using an interpreter. Persons and/or programmers of normal skill in the art may readily write the instructions and/or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include at least one of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

While various example embodiments have been described, it will be apparent to one of normal skill in the art that various changes in form and details may be made in these examples without departing from the spirit and scope of the claims and their equivalents.

1. A method comprising:
calculating a quantization sensitivity baseline set for each of a plurality of layers of a neural network model, wherein the quantization sensitivity baseline set includes a plurality of quantization sensitivity baselines, and wherein each of the plurality of quantization sensitivity baselines is based on a different corresponding set of bit widths, respectively;
calculating a quantization error of a candidate bit width strategy based on the quantization sensitivity baseline set, wherein the candidate bit width strategy allocates a target bit width to each of the plurality of layers;
selecting a bit width for each of the plurality of layers based on the quantization error; and
processing multimedia data using the neural network model based on the selected bit width.

2. The method of claim 1, wherein each of the plurality of quantization sensitivity baselines of the quantization sensitivity baseline set of an n-th layer of the plurality of layers quantizes the n-th layer to a first bit width of the corresponding set of bit widths and quantizes a previous layer of the plurality of layers to a second bit width of the corresponding set of bit widths.

3. The method of claim 2, wherein the previous layer is configured to provide input for the n-th layer in a forward propagation process.

4. The method of claim 1, wherein the quantization sensitivity baseline set is calculated based on a distance between an output of the neural network model before quantization and an output of the neural network model after quantization.

5. The method of claim 1, wherein the calculating of the quantization error comprises:
calculating a quantization sensitivity of an m-th layer of the neural network model based on the target bit width of the m-th layer, wherein m is an integer greater than 1;
fitting the quantization sensitivity of the m-th layer based on the quantization sensitivity baseline set of the m-th layer to obtain fitting parameters of the m-th layer; and
calculating a quantization sensitivity of an (m+1)-th layer based on the fitting parameters of the m-th layer and the target bit width of the (m+1)-th layer.

6. The method of claim 5, wherein the calculating of the quantization sensitivity of the m-th layer comprises:
selecting a quantization sensitivity baseline from the plurality of quantization sensitivity baselines as the quantization sensitivity of the m-th layer when m is equal to 2; and
calculating the quantization sensitivity of the m-th layer using the fitting parameters of the (m−1)-th layer when m is greater than 2.

7. The method of claim 5, wherein the fitting of the quantization sensitivity of the m-th layer comprises:
approximating the quantization sensitivity of the m-th layer using a weighted sum of a first quantization sensitivity baseline of the plurality of quantization sensitivity baselines and a second quantization sensitivity baseline of the plurality of quantization sensitivity baselines.

8. The method of claim 7, wherein the first quantization sensitivity baseline and the second quantization sensitivity baseline are selected based on a comparison between the calculated quantization sensitivity of the m-th layer and the plurality of quantization sensitivity baselines of the m-th layer.

9. The method of claim 8, wherein the first quantization sensitivity baseline and the second quantization sensitivity baseline correspond to quantization sensitivity baselines closest to the quantization sensitivity of the m-th layer.

10. The method of claim 5, wherein the calculating of the quantization sensitivity of the (m+1)-th layer using the fitting parameters of the m-th layer comprises:
computing a weighted sum of a third quantization sensitivity baseline and a fourth quantization sensitivity baseline of the plurality of quantization sensitivity baselines of the (m+1)-th layer using the fitting parameters of the m-th layer.

11. The method of claim 1, wherein the multimedia data includes at least one of image data, voice data, and text data.

12. A method comprising:
dividing a neural network model into a plurality of blocks;
calculating a quantization sensitivity baseline set for each of a plurality of layers of a first block of the plurality of blocks, wherein the quantization sensitivity baseline set includes a plurality of quantization sensitivity baselines, and wherein each of the plurality of quantization sensitivity baselines is based on a different corresponding set of bit widths, respectively;
calculating a quantization sensitivity for the first block based on the quantization sensitivity baseline set and a candidate bit width strategy, wherein the candidate bit width strategy allocates a target bit width to each of the plurality of layers of the first block; and
selecting a bit width for each of the plurality of layers of the first block based on the quantization sensitivity; and
processing multimedia data using the neural network model based on the selected bit width.

13. The method of claim 12, wherein the first block comprises a plurality of parallel branches.

14. The method of claim 12, wherein each of the plurality of quantization sensitivity baselines of the quantization sensitivity baseline set of an n-th layer of the plurality of layers quantizes the n-th layer to a first bit width and quantizes a previous layer of the plurality of layers to a second bit width of the corresponding set of bit widths.

15. The method of claim 14, wherein the previous layer is configured to provide input for the n-th layer in a forward propagation process.

16. The method of claim 12, wherein the calculating of the quantization sensitivity comprises:
calculating a quantization sensitivity of an m-th layer of the neural network model based on a target bit width of the m-th layer, wherein m is an integer greater than 1;
fitting the quantization sensitivity of the m-th layer based on a quantization sensitivity baseline set of the m-th layer to obtain fitting parameters of the m-th layer; and
calculating a quantization sensitivity of an (m+1)-th layer based on the fitting parameters of the m-th layer and the target bit width of the (m+1)-th layer.

17. The method of claim 16, wherein the calculating of the quantization sensitivity of the m-th layer comprises:
selecting a quantization sensitivity baseline from the plurality of quantization sensitivity baselines as the quantization sensitivity of the m-th layer when m is equal to 2; and
calculating the quantization sensitivity of the m-th layer using the fitting parameters of the (m−1)-th layer when m is greater than 2.

18. The method of claim 16, wherein the fitting of the quantization sensitivity of the m-th layer comprises:
approximating the quantization sensitivity of the m-th layer using a weighted sum of a first quantization sensitivity baseline of the plurality of quantization sensitivity baselines and a second quantization sensitivity baseline of the plurality of quantization sensitivity baselines.

19. (canceled)

20. The method of 12, wherein selecting the bit width comprises:
obtaining a first Pareto boundary based on the quantization sensitivity of the first block;
obtaining a second Pareto boundary based on a quantization sensitivity of a second block of the plurality of blocks;
obtaining a first bit width strategy of the first block and a second bit width strategy of the second block based on the first Pareto boundary and the second Pareto boundary.

21. An electronic device comprising:
a sensitivity calculation module configured to calculate a quantization sensitivity baseline set for each of a plurality of layers of a neural network model, wherein the quantization sensitivity baseline set includes a plurality of quantization sensitivity baselines, and wherein each of the plurality of quantization sensitivity baselines is based on a different corresponding set of bit widths, respectively;
a quantization error calculation module configured to calculate a quantization error of a candidate bit width strategy based on the quantization sensitivity baseline set, wherein the candidate bit width strategy allocates a target bit width to each of the plurality of layers; and
a bit width selection module configured to select a bit width for each of the plurality of layers based on the quantization error.

22. (canceled)
